(19) United States
(12) Patent Application Publication
(10) Pub. No.: US 2026/0095649 A1
(43) Pub. Date: Apr. 2, 2026

(54) ELECTRONIC DEVICE, CONTROL METHOD THEREOF, AND RECORDING MEDIUM

(71) Applicant: CANON KABUSHIKI KAISHA, Tokyo (JP)

(72) Inventors: SHINYA TAKEICHI, Kanagawa (JP); DAIYU UENO, Tokyo (JP)

(21) Appl. No.: 19/330,591

(22) Filed: Sep. 16, 2025

(30) Foreign Application Priority Data
Oct. 2, 2024 (JP) 2024-173833

(51) Int. Cl. H04N 23/60; H04N 23/63

(52) U.S. Cl. CPC H04N 23/64; H04N 23/632

(57) ABSTRACT

An electronic device includes an operation unit configured to receive a first operation and a second operation subsequent to the first operation, an assignment unit configured to assign a function to each of the first and second operation in response to a user selecting the function, a processing unit configured to execute processing corresponding to the function assigned to the first operation in response to the operation unit receiving the first operation and execute processing corresponding to the function assigned to the second operation in response to the operation unit receiving the second operation, and a control unit configured to, when the user selects the function to be assigned to one of the first or second operation, perform control to notify the user of either a recommended function or a not recommended function based on the function assigned to the other of the first or second operation.

### BACKGROUND

### Field of the Technology

The present disclosure relates to an electronic device, a control method of the electronic device, and a recording medium.

### Description of the Related Art

Electronic devices such as digital cameras allow a user to assign a function (e.g., autofocus) selected by the user to a predetermined operation unit so that the function desired by the user can be executed by the user operating the corresponding unit during image capturing. Digital cameras are provided with various functions in addition to the autofocus function, and thus the number of functions to be assigned to operation units by the user has been increasing.

Some operation units are configured to receive a first operation and a second operation subsequent to the first operation for a single operation unit, and a function can be assigned to each of the first operation and the second operation. Japanese Patent Laid-Open No. 2001-346080 describes a digital camera including a shutter release button configured to be depressed to a first level and further depressed to a second level. Japanese Patent Laid-Open No. 2001-346080 also describes a technique in which image data representing a movie image is recorded on a recording medium when the shutter release button is depressed to the first level and image data representing a still image is recorded on the recording medium when the shutter release button is depressed to the second level.

### SUMMARY

The present disclosure is directed to providing an electronic device configured to prevent an inappropriate combination of functions to be assigned to operations from being selected by a user in the case of using an operation unit configured to receive a first operation and a second operation subsequent to the first operation.

According to an aspect of the present disclosure, an electronic device includes a first operation unit configured to receive a first operation and a second operation subsequent to the first operation; at least one memory storing a program; and at least one processor that, upon execution of the stored program, is configured to function as: an assignment unit configured to assign a function to each of the first operation and the second operation in response to a user selecting the function, a processing unit configured to execute processing corresponding to the function assigned to the first operation in response to the first operation unit receiving the first operation and execute processing corresponding to the function assigned to the second operation in response to the first operation unit receiving the second operation, and a control unit configured to, when the user selects the function to be assigned to one of the first operation or the second operation, perform control to notify the user of either a recommended function or a not recommended function based on the function assigned to the other of the first operation or the second operation.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of an image capturing apparatus according to an embodiment of the present disclosure.

FIG. 2A is an external view illustrating a front side of the image capturing apparatus according to the embodiment, FIG. 2B is an external view illustrating a rear side of the image capturing apparatus according to the embodiment, and FIG. 2C illustrates a configuration of an autofocus (AF)-ON button configured to receive a plurality of operations in the image capturing apparatus according to the embodiment.

FIG. 3 is a flowchart illustrating processing on the AF-ON button.

FIGS. 4A to 4K each illustrate an example of a screen for assigning a function to a half-press operation and a full-press operation of the AF-ON button.

FIGS. 5A and 5B are a flowchart illustrating processing for setting functions to be assigned to a half-press operation and a full-press operation of the AF-ON button.

FIGS. 6A to 6C each illustrate an information table indicating combinations of functions to be assigned to two-stage operations.

FIGS. 7A to 7C each illustrate an example of a member configured to perform two-stage input processing other than the AF-ON button.

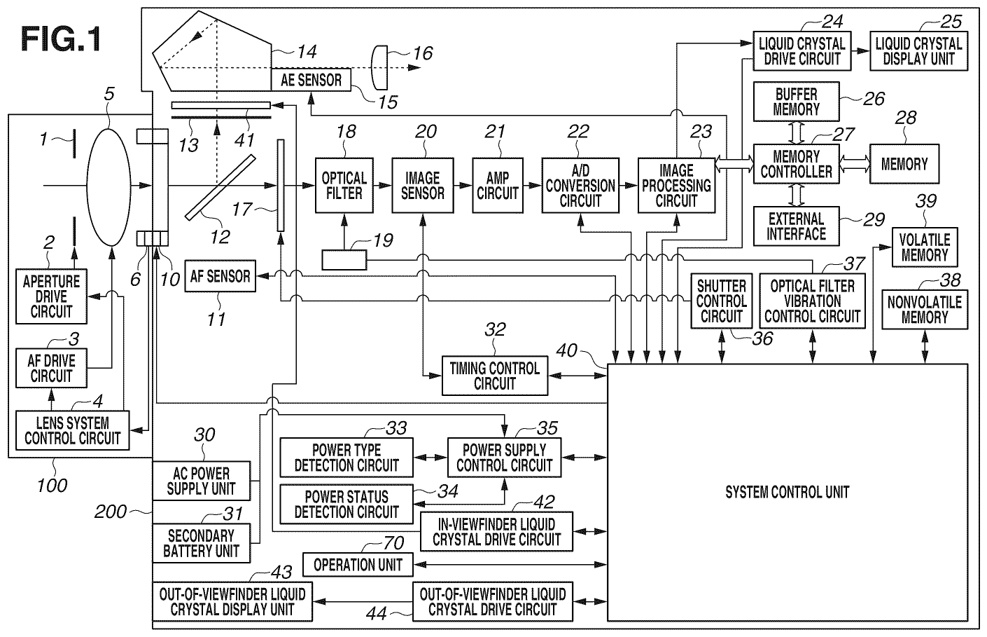

### DESCRIPTION OF THE EMBODIMENTS

Embodiments of the present disclosure will be described in detail below with reference to the accompanying drawings.

In the specification and the drawings, components including substantially the same functions and configurations may be denoted by the same reference numerals and redundant descriptions are therefore omitted. An image capturing apparatus 200 is described as an example of an electronic device according to an embodiment of the present disclosure. However, the present disclosure is not limited to this example.

### Configuration of Image Capturing Apparatus 200

A lens unit 100 includes an interchangeable lens 5. The lens 5 generally includes a plurality of lenses. In this case, however, only one lens is illustrated for simplicity.

A communication terminal 6 is used for the lens unit 100 to communicate with the image capturing apparatus 200. A communication terminal 10 is used for the image capturing apparatus 200 to communicate with the lens unit 100.

The lens unit 100 communicates with a system control unit 40 via the communication terminals 6 and 10. A lens system control circuit 4 in the lens unit 100 controls an aperture 1 via an aperture drive circuit 2 and adjusts the focus by displacing the position of the lens 5 via an autofocus (AF) drive circuit 3. The system control unit 40 obtains a maximum aperture value and a minimum aperture value of the lens unit 100 via the communication terminals 6 and 10.

An automatic exposure (AE) sensor 15 measures the luminance of an object through the lens unit 100.

An AF sensor 11 outputs defocus amount information to the system control unit 40. The system control unit 40 controls the lens unit 100 based on the defocus amount information.

A quick return mirror 12 is moved up and down by an actuator (not illustrated) during exposure based on an instruction from the system control unit 40.

A user can check the focus and composition of an optical image of an object obtained through the lens unit 100 by observing a focusing screen 13 via a pentaprism 14 and a viewfinder 16.

A focal plane shutter 17 is configured to freely control an exposure time for an image sensor 20 under the control of the system control unit 40.

An optical filter 18 generally includes a low-pass filter and the like and is configured to cut high-frequency components of light entering from the focal plane shutter 17 and guide the optical image of the object to the image sensor 20.

As the image sensor 20, a charge-coupled device (CCD) sensor, a complementary metal-oxide-semiconductor (CMOS) sensor, or the like is generally used. The image sensor 20 photoelectrically converts an object image formed on the image sensor 20 through the lens unit 100 and captures the object image as an electric signal.

An AMP circuit 21 amplifies the captured electric signal with a gain corresponding to a set image capturing sensitivity, thus producing an image capturing signal.

An analog-to-digital (A/D) conversion circuit 22 converts the electric signal from the image sensor 20, which is in the form of an analog signal, into a digital signal.

An image processing circuit 23 performs filter processing, color conversion processing, and gamma/knee processing on image data in a digital signal format, obtained from the A/D conversion circuit 22, and outputs the processed data to a memory controller 27. The image processing circuit 23 includes a digital-to analog (D/A) conversion circuit. The image processing circuit 23 is also configured to convert image data in a digital signal format, obtained from the A/D conversion circuit 22, or image data input from the memory controller 27 into an analog signal format, thus outputting the processed data to a liquid crystal display unit 25 via a liquid crystal drive circuit 24. The image processing and the display processing to be performed by the image processing circuit 23 are switched by the system control unit 40. The system control unit 40 performs a white balance adjustment based on color balance information about the captured image.

The liquid crystal display unit 25 is a rear monitor for displaying an image. The liquid crystal display unit 25 is not limited only to a liquid crystal display unit but instead may be a display of any other type, such as an organic electro-luminescence (EL) display, as long as the display unit is configured to display an image.

The memory controller 27 stores unprocessed image data into a buffer memory 26, and also stores processed image data, which is input from the image processing circuit 23, into a recording medium (memory) 28. The memory controller 27 also loads image data from the buffer memory 26 or the memory 28 and outputs the image data to the image processing circuit 23.

In addition, the memory controller 27 can store image data transmitted via an external interface 29 into the memory 28 and output image data stored in the memory 28 to an external apparatus via the external interface 29. Examples of the external interface 29 include a universal serial bus (USB), Institute of Electrical and Electronics Engineers (IEEE), and High-Definition Multimedia Interface (HDMI®) interfaces.

The memory 28 may be a detachable recording medium such as a memory card. The memory 28 may be a built-in memory. The system control unit 40 controls a drive timing of the image sensor 20 via the timing control circuit 32.

A power supply control circuit 35 is a circuit for controlling power to be supplied from an alternating current (AC) power supply unit 30 or a secondary battery unit 31. The power supply control circuit 35 turns on or off the power supply in response to an instruction from the system control unit 40. The power supply control circuit 35 provides the system control unit 40 with information about the current power state detected by a power status detection circuit 34 and information about the type of the current power detected by a power type detection circuit 33.

The system control unit 40 controls the focal plane shutter 17 via a shutter control circuit 36.

An optical filter vibration control circuit 37 is a circuit for vibrating a piezoelectric element 19 that is connected to the optical filter 18. The optical filter vibration control circuit 37 causes the piezoelectric element 19 to vibrate with predetermined values for vibration amplitude, vibration duration, and vibration axis direction, in accordance with instructions from the system control unit 40.

A non-volatile memory 38 is a non-volatile recording medium and is configured to store setting values for a shutter speed, an aperture value, an image capturing sensitivity, and the like that have been freely set by the user, as well as other various types of data even in a state where the image capturing apparatus 200 is not powered on.

A volatile memory 39 is configured to store data to be temporarily stored, such as information about the internal status of the image capturing apparatus 200 and information about the detachable memory 28.

An in-viewfinder liquid crystal display unit 41 displays, via an in-viewfinder liquid crystal drive circuit 42, a frame indicating a focus measurement point at which autofocusing is currently performed, icons indicating camera setting statuses, and the like.

An out-of-viewfinder liquid crystal display unit 43 displays various camera setting values, including the shutter speed and the aperture, via an out-of-viewfinder liquid crystal drive circuit 44.

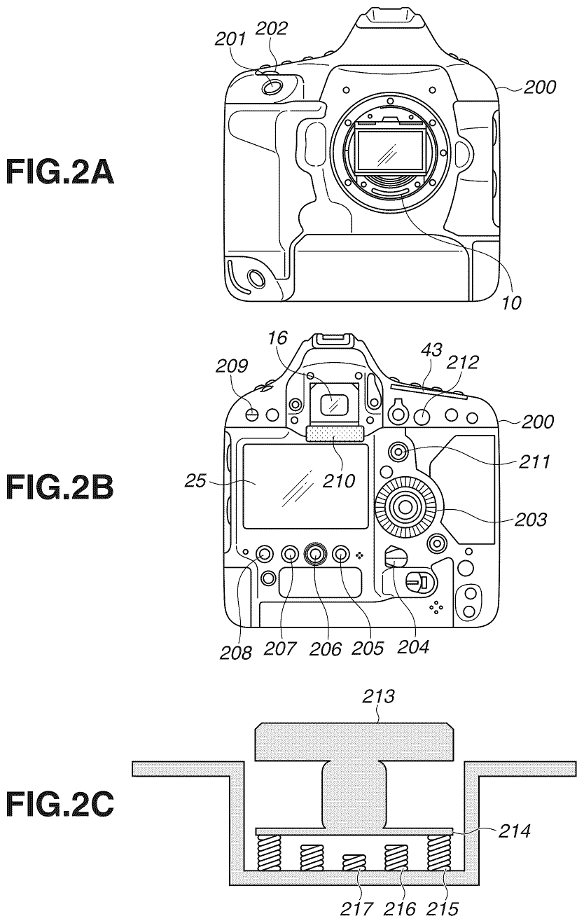

An operation unit 70 includes various operating members each serving as an input unit that receives an operation from the user. As illustrated in FIGS. 2A and 2B, the operation unit 70 includes a release button 201, an electronic main dial 202, an electronic sub-dial 203, a power switch 204, and a protect button 205. As illustrated in FIG. 2B, the operation unit 70 also includes a delete button 206, an enlargement mode button 207, a playback instruction button 208, a menu button 209, a multi-controller 211, and an AF-ON button 212.

The system control unit 40 is a control unit that controls each unit included in the image capturing apparatus 200. The system control unit 40 loads programs recorded on the non-volatile memory 38 using the volatile memory 39 as a working memory and executes the programs to thereby execute various processing operations to be described below.

### Description of External View of Image Capturing Apparatus 200

FIG. 2A is an external view illustrating a front side of the image capturing apparatus 200. FIG. 2B is an external view illustrating a rear side of the image capturing apparatus 200.

The release button 201 is used for issuing an image capturing preparation instruction and an image capturing instruction. When the release button 201 is half pressed, the luminance of an object is measured and focusing is performed. When the release button 201 is fully pressed, the shutter is released and an image of the object is captured.

The electronic main dial 202 is a rotary operation member. By rotating the electronic main dial 202, the user can set setting values for the shutter speed, the aperture, and the like, and fine-tune an enlargement ratio in an enlargement mode.

The electronic sub-dial 203 is a rotary operation member. By rotating the electronic sub-dial 203, the user can set setting values for the aperture, exposure compensation, and the like, and perform an image-by-image playback operation in an image display state.

The power switch 204 is an operation member for turning on or off the power supply.

The protect button 205 is used for performing processing such as protection or rating on an image stored in a recording medium inside or outside of the image capturing apparatus 200.

The delete button 206 is used for issuing an instruction to delete an image stored in the recording medium inside or outside of the image capturing apparatus 200.

The enlargement mode button 207 is used for receiving an operation to issue an instruction to start the enlargement mode so as to transition to the enlargement mode and an instruction to end the enlargement mode so as to exit from the enlargement mode in a playback state.

The playback instruction button 208 is used for causing the liquid crystal display unit 25 to display an image stored in the recording medium inside or outside of the image capturing apparatus 200.

The menu button 209 is a button for causing the liquid crystal display unit 25 to display various setting screens.

A finder eyepiece detection unit 210 is a sensor for detecting a state in which the user is looking through the viewfinder 16.

The multi-controller 211 is an operating member that can be operated in a plurality of directions to set the focus measurement point, which is a starting point for autofocusing, or to move an enlarged frame (enlarged area) in an enlarged image display state.

### Configuration of AF-ON Button 212

The AF-ON button 212 is an operation member for issuing an instruction to start autofocusing on an object in an image. FIG. 2C illustrates a configuration of the AF-ON button 212 configured to receive a plurality of operations. The AF-ON button 212 has a two-stage configuration. A two-stage operation on the AF-ON button 212 includes a first operation corresponding to “half-press operation” and a second operation corresponding to “full-press operation”subsequent to the first operation.

A key top 213 is configured to be exposed externally as a part that the user first touches when pressing the AF-ON button 212.

A conductive member 214 is connected to the key top 213 and is configured to be descended by a force applied from the top.

A ground spring 215 is connected to the conductive member 214 and is installed on the ground.

A half-press operation detection spring 216 of the AF-ON button 212 is configured to be brought into contact with the conductive member 214 that is descended by the force applied from the key top 213. Since the conductive member 214 is connected to the ground spring 215 that is connected to the ground, a half-press operation is detected when the conductive member 214 and the half-press operation detection spring 216 of the AF-ON button 212 come into contact with each other.

A full-press operation detection spring 217 of the AF-ON button 212 is configured to be brought into contact with the conductive member 214 that is descended by the force applied from the key top 213. As in the half-press operation detection spring 216 of the AF-ON button 212, a full-press operation is detected when the conductive member 214 and the full-press operation detection spring 217 of the AF-ON button 212 come into contact with each other.

The full-press operation detection spring 217 of the AF-ON button 212 is configured to have a lower height than the half-press operation detection spring 216 of the AF-ON button 212. This configuration ensures detection of the half-press operation of the AF-ON button 212 when the full-press operation of the AF-ON button 212 is detected. In other words, when the half-press operation and the full-press operation are detected in this order, a function assigned to the half-press operation and a function assigned to the full-press operation are started in this order, so that the function assigned to the half-press operation is continuously performed while the function assigned to the full-press operation is started.

### Processing Relating to AF-ON Button 212

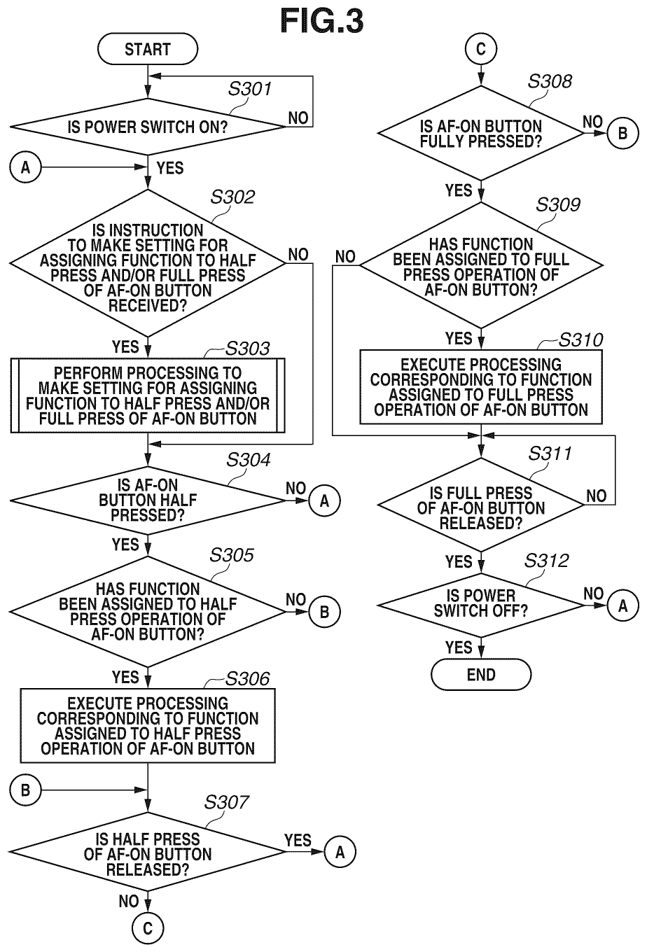

Processing relating to the AF-ON button 212 will now be described with reference to a flowchart illustrated in FIG. 3. In this processing, other processing such as image capturing processing according to a shutter button operation is also executed in parallel with this processing in the processing relating to the AF-ON button 212 in an image capturing mode of the image capturing apparatus 200. This processing is implemented such that a program recorded on the non-volatile memory 38 is loaded into the volatile memory 39 and the program is executed by the system control unit 40.

In step S301, the system control unit 40 determines whether the power switch 204 is ON. If the power switch 204 is ON (YES in step S301), the processing proceeds to step S302. If the power switch 204 is not ON (NO in step S301), the processing returns to step S301.

In step S302, the system control unit 40 determines whether an instruction to make a setting for assigning a function to the half-press operation and/or the full-press operation of the AF-ON button 212 is received from the user. If it is determined that the instruction to make a setting for assigning a function to the half-press operation or the full-press operation of the AF-ON button 212 is received (YES in step S302), the processing proceeds to step S303. Otherwise (NO in step S302), the processing proceeds to step S304.

In step S303, the system control unit 40 performs processing to make a setting for assigning a function to the half-press operation and/or the full-press operation of the AF-ON button 212. This processing will be described in detail below.

In step S304, the system control unit 40 determines whether the AF-ON button 212 is half-pressed by the user. If it is determined that the AF-ON button 212 is half-pressed (YES in step S304), the processing proceeds to step S305. Otherwise (NO in step S304), the processing returns to step S302.

In step S305, the system control unit 40 determines whether a function has been assigned to the half-press operation of the AF-ON button 212. If it is determined that a function has been assigned to the half-press operation of the AF-ON button 212 (YES in step S305), the processing proceeds to step S306. Otherwise (NO in step S305), the processing proceeds to step S307 without executing the processing of step S306. Here, if no function has been assigned to the half-press operation of the AF-ON button 212, the item indicating the function set to the half-press operation of the AF-ON button 212 is displayed as “Disabled” on an advanced settings screen 400 to be described below.

In step S306, the system control unit 40 executes processing corresponding to the function assigned to the half-press operation of the AF-ON button 212.

In step S307, the system control unit 40 determines whether the half-press operation of the AF-ON button 212 is released. If it is determined that the half-press operation of the AF-ON button 212 is released (YES in step S307), the processing returns to step S302. If it is determined that the half-press operation of the AF-ON button 212 is not released (NO in step S307), the processing proceeds to step S308.

In step S308, the system control unit 40 determines whether the AF-ON button 212 is fully pressed by the user. If it is determined that the AF-ON button 212 is fully pressed (YES in step S308), the processing proceeds to step S309. Otherwise (NO in step S308), the processing returns to step S307.

In step S309, the system control unit 40 determines whether a function has been assigned to the full-press operation of the AF-ON button 212. If it is determined that a function has been assigned to the full-press operation of the AF-ON button 212 (YES in step S309), the processing proceeds to step S310. Otherwise (NO in step S309), the processing proceeds to step S311 without executing the processing of step S310.

In step S310, the system control unit 40 executes processing corresponding to the function assigned to the full-press operation of the AF-ON button 212.

In step S311, the system control unit 40 determines whether the full-press operation of the AF-ON button 212 is released. If it is determined that the full-press operation of the AF-ON button 212 is released (YES in step S311), the processing proceeds to step S312. Otherwise (NO in step S311), the processing returns to step S311. Alternatively, if the full-press operation of the AF-ON button 212 is released in step S311, the processing may return to step S304, and if the half-press operation of the AF-ON button 212 is continued, the function assigned to the half-press operation may be executed.

In step S312, the system control unit 40 determines whether the power switch 204 is OFF. If it is determined that the power switch 204 is OFF (YES in step S312), the processing ends. Otherwise (NO in step S312), the processing returns to step S302.

### Screen for Assigning Function to Half-press Operation and Full-press Operation of AF-ON Button 212

According to the present embodiment, functions other than the function of issuing an instruction to start autofocusing can be assigned to the AF-ON button 212. In the present embodiment, the user can assign a function to each of the half-press operation and the full-press operation of the AF-ON button 212. With this configuration, a function desired by the user can be assigned to each of the half-press operation and the full-press operation of the AF-ON button 212.

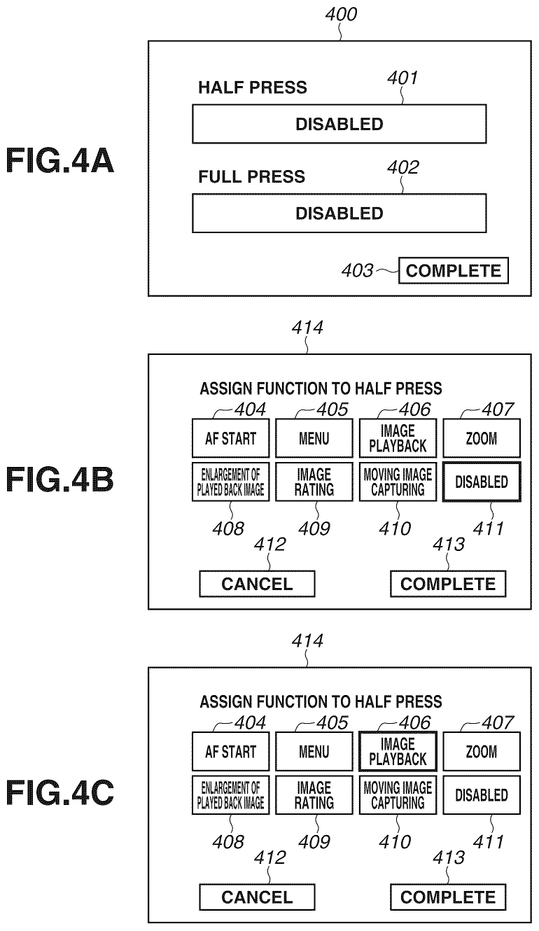

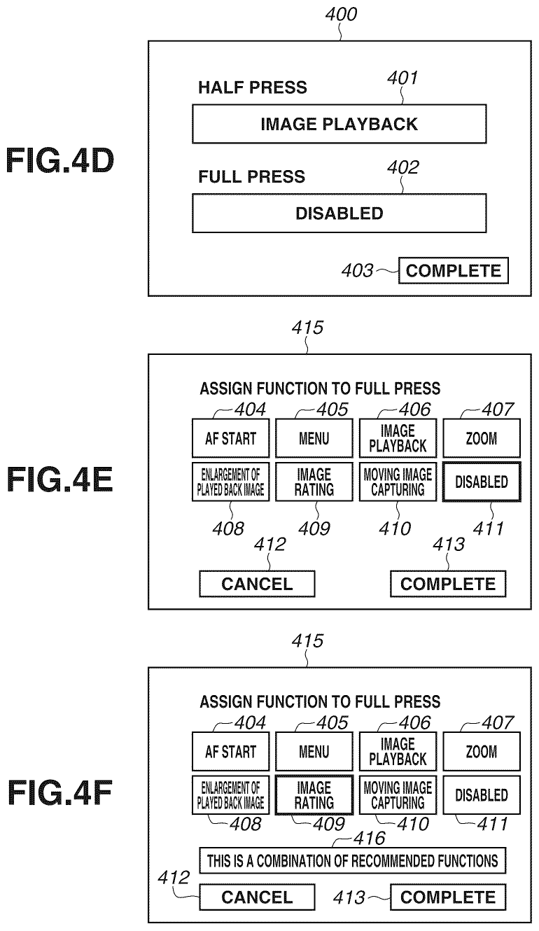

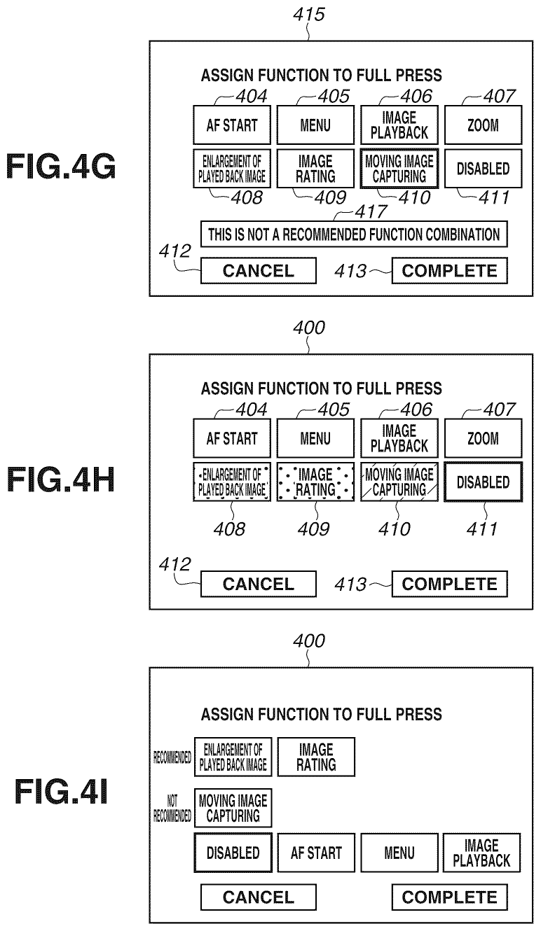

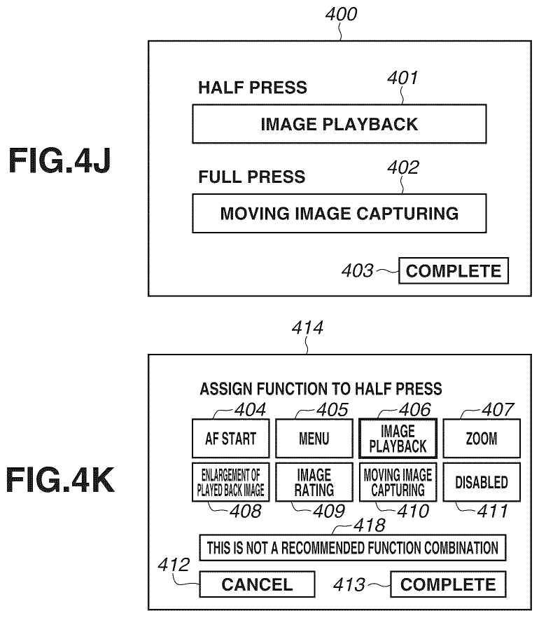

FIG. 4A illustrates the advanced settings screen 400 for changing and setting functions to be assigned to the half-press operation and the full-press operation by a user operation. The advanced settings screen 400 is displayed through the following processing. After a “button customize” item is selected on a menu screen, an item corresponding to “AF-ON button 212” is selected and a combination in which both functions settable to the half-press operation and the full-press operation of the AF-ON button 212 are set to “Disabled” is selected. The term “Disabled” used herein indicates that no function has been assigned to the corresponding operation, the half-press operation or the full-press operation of the AF-ON button 212.

As illustrated in FIG. 4A, the advanced settings screen 400 displays a half-press operation setting icon 401 for the AF-ON button 212, a full-press operation setting icon 402 for the AF-ON button 212, and a complete icon 403. On each of the half-press operation setting icon 401 and the full-press operation setting icon 402 for the AF-ON button 212, “disabled,” indicating that no function has been assigned to each of the half-press operation and the full-press operation of the AF-ON button 212, is displayed.

As illustrated in FIG. 4B, on the advanced settings screen 400, when the user selects the half-press operation setting icon 401 for the AF-ON button 212, a function assignment screen 414 for the half-press operation is displayed. On the function assignment screen 414 for the half-press operation, selectable functions are displayed as icons and the icons are arranged in a lattice pattern. A display form of an icon corresponding to a function can be changed to indicate that the function is currently selected by the user. For example, the icon corresponding to the selected function can be highlighted to indicate that the function is currently selected. FIG. 4B illustrates an example where the border of the icon for “disabled” 411 is changed to a bold frame, indicating that “disabled” 411 is currently selected.

Examples of the function to be assigned to the half-press operation include start of autofocusing (AF start 404), transition to the menu screen (menu 405), playback of a captured image (image playback 406), and zooming of a live-view image (zoom 407). Other examples of the function to be assigned to the half-press operation include enlargement of a played back image (enlargement of played back image 408), assignment of a rating to an image (image rating 409), and starting of moving image capturing (moving image capturing 410).

On the function assignment screen 414 for the half-press operation, the function to be assigned to the half-press operation can be changed to a function desired by the user from “disabled” 411 with a selection operation by the user. For example, while FIG. 4B illustrates an example where the “disabled” 411 is selected as the function to be assigned to the half-press operation, FIG. 4C illustrates an example where image playback 406 is selected as the function to be assigned to the half-press operation. If a selection operation on a complete icon 413 is performed by the user in a state where image playback 406 is selected, an instruction to change the function to be assigned to the half-press operation is received and then the screen returns to the advanced settings screen 400 as illustrated in FIG. 4D. FIG. 4D illustrates an example where “image playback” is displayed on the half-press operation setting icon 401 for the AF-ON button 212 on the advanced settings screen 400. If a selection operation on a cancel icon 412 is performed by the user in a state where the image playback 406 is selected as illustrated in FIG. 4C, the screen returns to the advanced settings screen 400 without receiving the instruction to change the function to be assigned to the half-press operation. In this case, the function to be assigned to the half-press operation is not changed and thus “disabled” is still assigned to the half-press operation. Accordingly, “disabled” is displayed on the half-press operation setting icon 401 for the AF-ON button 212 on the advanced settings screen 400 as illustrated in FIG. 4A.

On the advanced settings screen 400, a function assignment screen 415 for the full-press operation is displayed upon performance of a selection operation on the full-press operation setting icon 402 for the AF-ON button 212 by the user, as illustrated in FIG. 4E. As in the function assignment screen 414 for the half-press operation, the function assignment screen 415 for the full-press operation displays selectable functions as icons and the icons are arranged in a lattice pattern. Selectable functions displayed on the function assignment screen 415 for the full-press operation are similar to the functions displayed on the function assignment screen 414 for the half-press operation.

On the function assignment screen 415 for the full-press operation, the function to be assigned to the full-press operation can be changed to a function desired by the user from “disabled” 411 with a selection operation by the user. While FIG. 4E illustrates an example where “disabled” 411 is selected as the function to be assigned to the full-press operation, FIG. 4F illustrates an example where image rating 409 is selected as the function to be assigned to the full-press operation. Further, in the example illustrated in FIG. 4F, a notification indicating whether the function selected by the user as the function to be assigned to the full-press operation is recommended in combination with the function assigned to the half-press operation. Specifically, the image rating 409 selected by the user as the function to be assigned to the full-press operation is recommended in combination with the image playback function assigned to the half-press operation. Accordingly, guidance 416 indicating that “this is a combination of recommended functions” is displayed on the function assignment screen 415 for the full-press operation. This guidance may also include a reason why the selected function is a recommended function. In an example illustrated in FIG. 4G, moving image capturing 410 is selected as the function to be assigned to the full-press operation by the user. Moving image capturing 410 is not recommended in combination with the image playback function assigned to the half-press operation. Accordingly, guidance 417 indicating that “This is not a recommended function combination” is displayed on the function assignment screen 415 for the full-press operation. This guidance may also include a reason why the selected function is not recommended.

If a selection operation on the complete icon 413 is performed by the user in a state where image rating 409 is selected as illustrated in FIG. 4F, an instruction to change the function to be assigned to the full-press operation is received and then the screen returns to the advanced settings screen 400 (not illustrated). Thus, a combination of recommended functions is assigned to the half-press operation and the full-press operation of the AF-ON button 212. If a selection operation on the complete icon 403 is performed by the user on the advanced settings screen 400, a combination of recommended functions is set for the half-press operation and the full-press operation of the AF-ON button 212.

If a selection operation on the cancel icon 412 is performed by the user in a state where image rating 409 is selected as illustrated in FIG. 4F, the screen returns to the advanced settings screen 400 as illustrated in FIG. 4D without receiving the instruction to change the function to be assigned to the full-press operation. In this case, the function to be assigned to the full-press operation is not changed and thus “disabled” is still assigned to the full-press operation. Accordingly, “disabled” is displayed on the full-press operation setting icon 402 for the AF-ON button 212 on the advanced settings screen 400 as illustrated in FIG. 4D.

If a selection operation on the complete icon 413 is performed by the user in a state where the moving image capturing 410 is selected as illustrated in FIG. 4G, an instruction to change the function to be assigned to the full-press operation is received and then the screen returns to the advanced settings screen 400 as illustrated in FIG. 4J. Thus, a not recommended combination of functions is assigned to the half-press operation and the full-press operation of the AF-ON button 212. However, a function can be assigned to the half-press operation of the AF-ON button 212 again. The function assignment screen 414 for the half-press operation is displayed as illustrated in FIG. 4K with a selection operation on the half-press operation setting icon 401 for the AF-ON button 212 by the user on the advanced settings screen 400 illustrated in FIG. 4J. The image playback 406 is currently selected on the function assignment screen 414 for the half-press operation. The image playback 406 is a function not-recommended in combination with the moving image playback function assigned to the full-press operation. Accordingly, guidance 418 indicating that “This is not a recommended function combination” is displayed on the function assignment screen 414 for the half-press operation. However, the user can select a function again on the function assignment screen 414 for the half-press operation.

Thus, in a case where, after the user selects the function to be assigned to the half-press operation, the user selects a function to be assigned to the full-press operation, which is the other operation, a notification indicating whether the function to be selected is recommended in combination with the function assigned to the half-press operation is provided. Additionally, in a case where, after the user selects the function to be assigned to the full-press operation, the user selects a function to be assigned to the half-press operation, which is the other operation, a notification indicating whether the function to be selected is recommended in combination with the function assigned to the full-press operation is provided on the function assignment screen 414 for the half-press operation. This configuration makes it easier for the user to select an appropriate combination of functions to be assigned to the half-press operation and the full-press operation of the AF-ON button 212.

Further, in a case where, after the user selects the function to be assigned to the half-press operation, the user selects a function to be assigned to the full-press operation, which is the other operation, a notification indicating whether the function to be selected is not recommended in combination with the function assigned to the half-press operation is provided. Additionally, in a case where, after the user selects the function to be assigned to the full-press operation, the user selects a function to be assigned to the half-press operation, which is the other operation, a notification indicating whether the function to be selected is not recommended in combination with the function assigned to the full-press operation is provided on the function assignment screen 414 for the half-press operation. This configuration prevents the user from selecting an inappropriate combination of functions to be assigned to the half-press operation and the full-press operation of the AF-ON button 212.

While the present embodiment described above illustrates an example where a guidance display method is used as a method for notifying the user of a recommended function or a not recommended function combination, the notification may be provided by using different display forms for the recommended function and the not recommended function. For example, as illustrated in FIG. 4H, the icons corresponding to recommended functions may be displayed with dots, while the icons corresponding to not recommended functions may be displayed with diagonal lines. Additionally, whether a function is recommended or not may be indicated by changing the color of the icon itself, the color of the text within the icon, or the color of the border of the icon.

Further, as illustrated in FIG. 4I, the functions may be divided into groups of recommended functions (recommended) and not recommended functions (not recommended) to be displayed.

### Processing for Setting Function to be Assigned to Half-press Operation and Full-press Operation of AF-ON Button 212

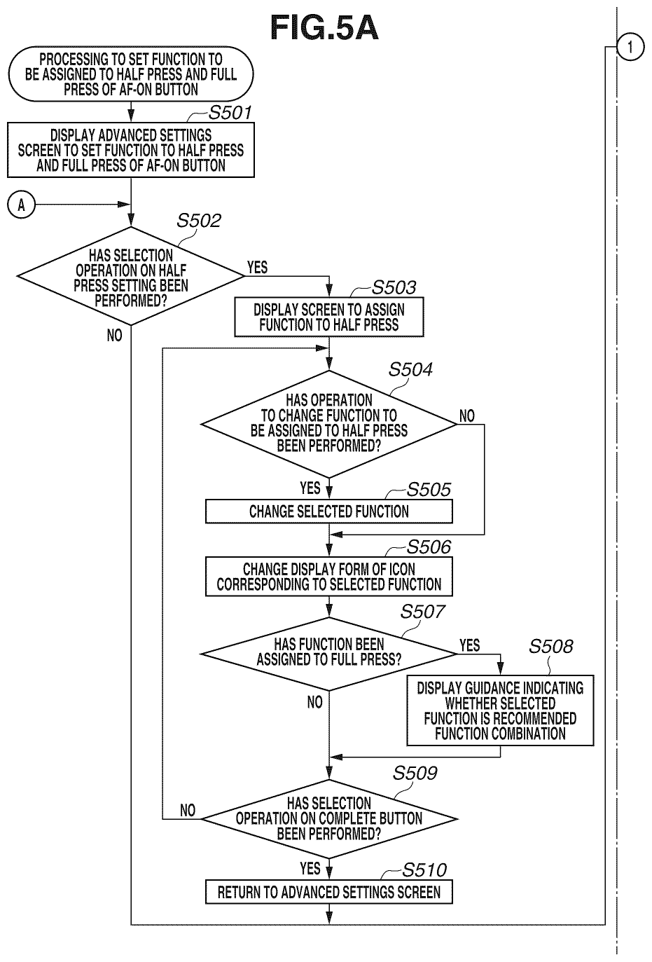

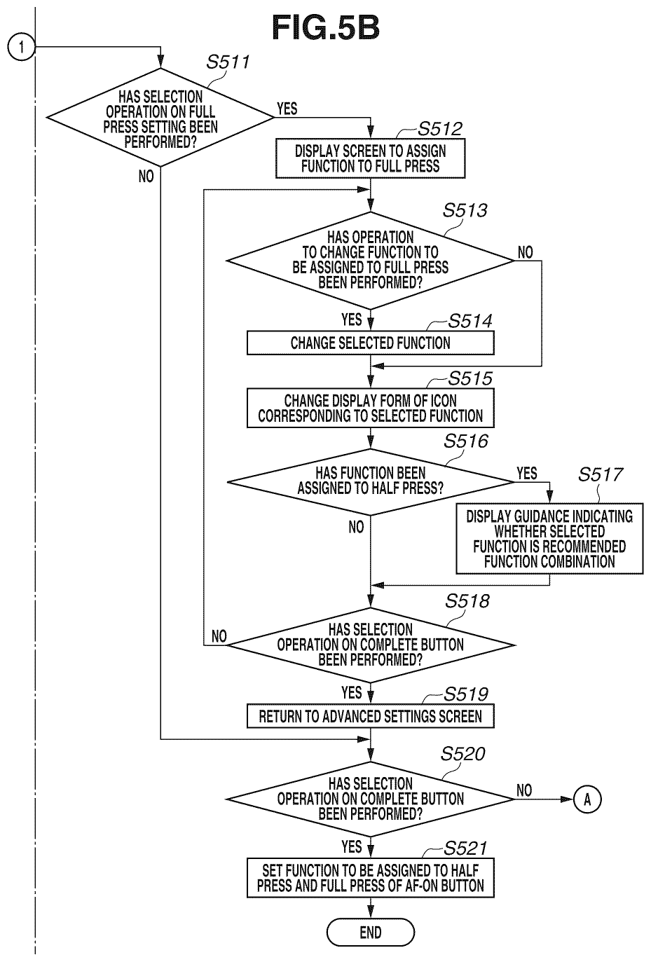

Processing for setting functions to be assigned to the half-press operation and the full-press operation of the AF-ON button 212 (processing of step S303) will be described with reference to a flowchart illustrated in FIGS. 5A and 5B.

The user can select a function to be assigned to each of the half-press operation and the full-press operation of the AF-ON button 212. The processing in FIGS. 5A and 5B is implemented such that a program recorded on the non-volatile memory 38 is loaded into the volatile memory 39, and the program is executed by the system control unit 40.

In step S501, the system control unit 40 displays the advanced settings screen 400 for setting functions to the half-press operation and the full-press operation of the AF-ON button 212 as illustrated in FIG. 4A. The advanced settings screen 400 is displayed through the following processing. After a “button customize” item is selected on a menu screen, an item corresponding to “AF-ON button 212” is selected and a combination in which both functions settable to the half-press operation and the full-press operation of the AF-ON button 212 are set to “disabled” is selected.

In step S502, the system control unit 40 determines whether a selection operation on the half-press operation setting icon 401 has been performed by the user on the advanced settings screen 400. If it is determined that the selection operation on the half-press operation setting icon 401 has been performed by the user (YES in step S502), the processing proceeds to step S503. Otherwise (NO in step S502), the processing proceeds to step S511.

In step S503, the system control unit 40 displays the function assignment screen 414 for the half-press operation as illustrated in FIG. 4B.

In step S504, the system control unit 40 determines whether an operation to change the function to be assigned to the half-press operation has been performed on the function assignment screen 414 for the half-press operation. If it is determined that the operation to change the function to be assigned to the half-press operation has been performed (YES in step S504), the processing proceeds to step S505. Otherwise (NO in step S504), the processing proceeds to step S506. Specifically, in the example illustrated in FIG. 4B, “disabled” 411 is selected as the function to be assigned to the half-press operation. If image playback 406 is selected with a change operation by the user (YES in step S504), the processing proceeds to step S505. If a change operation has not been performed by the user (NO in step S504) and “disabled” 411 remains selected, the processing proceeds to step S506.

In step S505, the system control unit 40 changes the currently selected function in response to the user performing the operation to change the function to be assigned to the half-press operation on the function assignment screen 414 for the half-press operation. Specifically, in the example illustrated in FIG. 4B, although “disabled” 411 is selected as the function to be assigned to the half-press operation, if image playback 406 is selected, the currently selected function is changed to image playback 406 from “disabled”411.

In step S506, the system control unit 40 changes the display form of the icon corresponding to the currently selected function. Specifically, the border of the icon corresponding to image playback 406 currently selected as the function is changed to a bold frame as illustrated in FIG. 4C.

In step S507, the system control unit 40 determines whether a function has been assigned to the full-press operation. If it is determined that a function has been assigned to the full-press operation (YES in step S507), the processing proceeds to step S508. Otherwise (NO in step S507), the processing proceeds to step S509.

In step S508, the system control unit 40 displays guidance indicating whether the function currently selected as the function to be assigned to the half-press operation is recommended in combination with the function assigned to the full-press operation as illustrated in FIG. 4K. This guidance is displayed on the function assignment screen 414 for the half-press operation. Thus, the guidance is displayed before the currently selected function is assigned to the half-press operation. Since the user can check a combination of functions to be assigned to the half-press operation and the full-press operation in advance, the user can more effectively perform subsequent setting operations.

In step S509, the system control unit 40 determines whether a selection operation on the complete icon 413 has been performed by the user on the function assignment screen 414 for the half-press operation. If it is determined that the selection operation on the complete icon 413 has been performed (YES in step S509), the processing proceeds to step S510. Otherwise (NO in step S509), the processing proceeds to step S504.

In step S510, the system control unit 40 returns to the advanced settings screen 400 as illustrated in FIG. 4A, FIG. 4D, or FIG. 4J.

In step S511, the system control unit 40 determines whether a selection operation on the full-press operation setting icon 402 has been performed by the user on the advanced settings screen 400. If it is determined that the selection operation on the full-press operation setting icon 402 has been performed by the user (YES in step S511), the processing proceeds to step S512. Otherwise (NO in step S511), the processing proceeds to step S520.

In step S512, the system control unit 40 displays the function assignment screen 415 for the full-press operation as illustrated in FIG. 4E.

In step S513, the system control unit 40 determines whether an operation to change the function to be assigned to the full-press operation has been performed on the function assignment screen 415 for the full-press operation. If it is determined that an operation to change the function to be assigned to the full-press operation has been performed (YES in step S513), the processing proceeds to step S514. Otherwise (NO in step S513), the processing proceeds to step S515. Specifically, in the example illustrated in FIG. 4E, “disabled” 411 is selected as the function to be assigned to the full-press operation. If image rating 409 is selected with a change operation by the user (YES in step S513), the processing proceeds to step S514. If a change operation has not been performed by the user (NO in step S513) and “disabled” 411 remains selected, the processing proceeds to step S515.

In step S514, the system control unit 40 changes the currently selected function when the operation to change the function to be assigned to the full-press operation is performed on the function assignment screen 415 for the full-press operation. Specifically, in the example illustrated in FIG. 4E, although “disabled” 411 is selected as the function to be assigned to the full-press operation, if image rating 409 is selected, the currently selected function is changed from “disabled” 411 to image rating 409.

In step S515, the system control unit 40 changes the display form of the icon corresponding to the currently selected function. Specifically, the border of the icon corresponding to image rating 409 currently selected as the function is changed to a bold frame as illustrated in FIG. 4F.

In step S516, the system control unit 40 determines whether a function has been assigned to the half-press operation. If it is determined that a function has been assigned to the half-press operation (YES in step S516), the processing proceeds to step S517. Otherwise (NO in step S516), the processing proceeds to step S518.

In step S517, the system control unit 40 displays guidance indicating whether the function currently selected as the function to be assigned to the full-press operation is recommended in combination with the function assigned to the half-press operation as illustrated in FIG. 4F or FIG. 4G. This guidance is displayed on the function assignment screen 415 for the full-press operation.

Thus, the guidance is displayed before the currently selected function is assigned to the full-press operation. Since the user can check a combination of functions to be assigned to the half-press operation and the full-press operation in advance, the user can more effectively perform subsequent setting operations.

In step S518, the system control unit 40 determines whether a selection operation on the complete icon 413 has been performed by the user on the function assignment screen 415 for the full-press operation. If it is determined that a selection operation on the complete icon 413 has been performed (YES in step S518), the processing proceeds to step S519. Otherwise (NO in step S518), the processing returns to step S513.

In step S519, the system control unit 40 returns to the advanced settings screen 400 as illustrated in FIG. 4A or FIG. 4D.

In step S520, the system control unit 40 determines whether a selection operation on the complete icon 403 has been performed by the user on the advanced settings screen 400. If it is determined that a selection operation on the complete icon 403 has been performed (YES in step S520), the processing proceeds to step S521. Otherwise (NO in step S520), the processing returns to step S502.

In step S521, the system control unit 40 sets the functions to be assigned to the half-press operation and the full-press operation of the AF-ON button 212, and then the processing ends.

### Combination of Functions to be Assigned to Half-Press Operation and Full-Press Operation of AF-ON Button 212

If the half-press operation and the full-press operation on the AF-ON button 212 are performed in this order, the function assigned to the half-press operation and the function assigned to the full-press operation are executed in this order. Specifically, the function assigned to the half-press operation is executed and then a function related to the function assigned to the half-press operation is subsequently executed. Accordingly, as the function to be assigned to the full-press operation of the AF-ON button 212, the functions that can be executed after the function assigned to the half-press operation of the AF-ON button is executed are recommended. On the other hand, the functions unrelated to the function assigned to the half-press operation of the AF-ON button 212 are not recommended as the function to be assigned to the full-press operation. In other words, as the function to be assigned to the full-press operation of the AF-ON button 212, the functions that cannot be executed after the function assigned to the half-press operation of the AF-ON button 212 is executed are not recommended. In addition, as the function to be assigned to the full-press operation of the AF-ON button 212, the functions that can be executed after the function assigned to the half-press operation of the AF-ON button is executed but are not desired by the user are also not recommended.

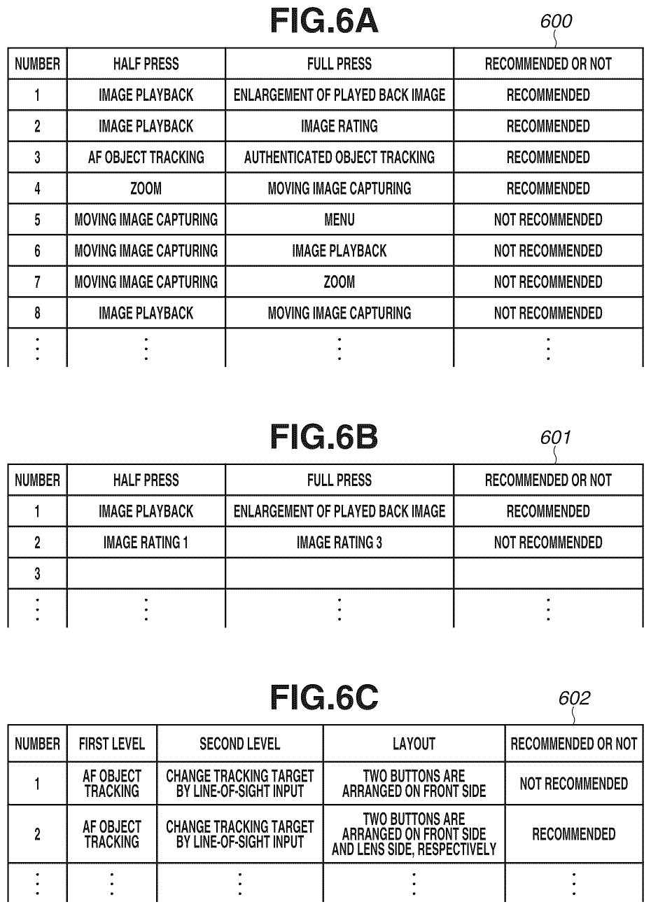

FIG. 6A illustrates an information table indicating combinations of functions to be assigned to the half-press operation and the full-press operation of the AF-ON button 212. FIG. 6A illustrates an information table 600 indicating combinations of functions assuming that the function assigned to the half-press operation is executed and then a function related to the function assigned to the half-press operation is subsequently executed. The image capturing apparatus 200 stores the information table 600 indicating combinations of functions in the non-volatile memory 38. The system control unit 40 displays guidance with reference to the information table 600 indicating combinations of functions as in steps S508 and S517 in the flowchart of FIGS. 5A and 5B.

For example, in a case where the image playback function is assigned to the half-press operation and the image rating function is selected as the function to be assigned to the full-press operation, the combination of the functions corresponds to Number 2 in the information table 600 indicating combinations of functions. The combination corresponding to Number 2 is “recommended.” Accordingly, in step S517, the system control unit 40 displays the guidance 416 indicating that “this is a combination of recommended functions” on the function assignment screen 415 for the full-press operation.

In contrast, in a case where the image playback function is assigned to the half-press operation and the moving image capturing function is selected as the function to be assigned to the full-press operation, the combination of the functions corresponds to Number 8 in the information table 600 indicating combinations of functions. The combination corresponding to Number 8 is “not recommended.” Accordingly, in step S517, the system control unit 40 displays the guidance 417 indicating that “this is not a recommended function combination” on the function assignment screen 415 for the full-press operation.

In a case where the full-press operation and the half-press operation on the AF-ON button 212 are performed in this order, the function assigned to the full-press operation and the function assigned to the half-press operation may be executed in this order. In this case, the function assigned to the full-press operation is executed and a function related to the function assigned to the full-press operation is subsequently executed. Thus, it is necessary to consider not only recommending or not recommending combinations of functions to be assigned based on the function assigned to the half-press operation but also based on the function assigned to the full-press operation.

In this regard, FIG. 6B illustrates an information table 601 indicating combinations of functions covering both cases: a case where the function assigned to the half-press operation is used as the basis, and a case where the function assigned to the full-press operation is used as the basis. The image capturing apparatus 200 stores the information table 601 indicating combinations of functions in the non-volatile memory 38. The system control unit 40 refers to the information table 601 indicating combinations of functions to display guidance, as in steps S508 and S517 in the flowchart of FIGS. 5A and 5B.

Specifically, Number 1 illustrated in FIG. 6B indicates that image playback is assigned to the half-press operation and played-back image enlargement is assigned to the full-press operation. In this case, played-back image enlargement is a desirable function as the function to be executed after the image playback function is executed. Image playback is also a desirable function to be executed after played-back image enlargement is executed. For this reason, the combination corresponding to Number 1 is “recommended.” On the other hand, Number 2 indicates that an image rating assignment of “1” (image rating 1), which is the lowest level among five levels, is assigned to the half-press operation. An image rating assignment of “3” (image rating 3), which is the middle level among the five levels, is assigned to the full-press operation. In this case, an image rating assignment of “3” among the five levels is a desirable function to be executed after an image rating assignment of “1” among the five levels is executed. However, an image rating assignment of “1” among the five levels is an undesirable function to be executed after an image rating assignment of “3” among the five levels is executed. For this reason, the combination corresponding to Number 2 is “not recommended.”

According to the embodiment of the present disclosure, it is possible to prevent an inappropriate combination of functions to be assigned to operations from being selected by the user in a case involving use of an operation unit configured to receive a first operation and a second operation subsequent to the first operation.

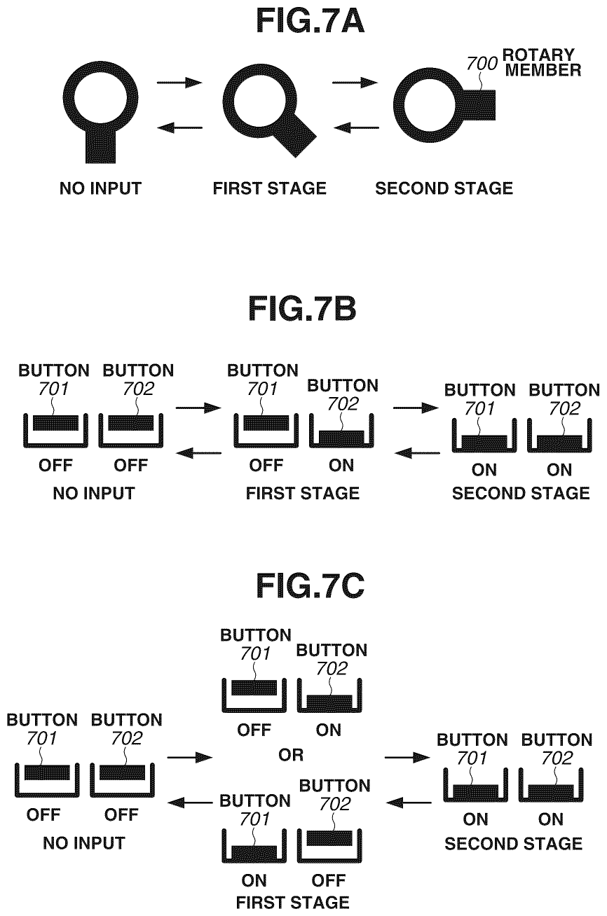

While the present embodiment described above illustrates a case where the AF-ON button 212 is used as a member configured to perform a two-stage operation and receive a half-press operation and a full-press operation, a rotary member 700 illustrated in FIG. 7A can also be used as the operation member. When the user rotates the rotary member 700 counterclockwise, the rotary member 700 sequentially transitions to a first-stage state and a second-stage state from a no-input state. When the user rotates the rotary member 700 clockwise from the second-stage state, the rotary member 700 sequentially returns to the first-stage state and then to the no-input state. The operation member does not necessarily have to be configured with a single component. For example, a combination of two components each having two states, that is, an ON state and an OFF state, may be regarded as a single operation member, and the operation member may be configured to transition from the no-input state to the first-stage state and then to the second-stage state. Further, the operation member may sequentially return from the second-stage state to the first-stage state and then to the no-input state.

FIG. 7B illustrates an example where a combination of two components each having two states, that is, the ON state and the OFF state, is used. Initially, a button 701 and a button 702 are not in a pressed state (no input). Pressing the button 702 causes a transition to the first stage state, and pressing the button 701 while continuing to press the button 702 causes a transition to the second stage state. From the state where both the button 701 and the button 702 are pressed, releasing the button 701 while continuing to press the button 702 causes a transition back to the first stage state, and further, releasing the button 702 returns to the initial state, which is no-input state.

FIG. 7C illustrates an example where a combination of two components each having two states, that is, the ON state and the OFF state, is used. The example of FIG. 7C is different from the example of FIG. 7B. Initially, the button 701 and the button 702 are not in a pressed state (no input). Pressing either the button 701 or the button 702 causes a transition to the first stage state, and pressing the other, which is the one not pressed in the first stage, while continuing to press the first button, causes a transition to the second stage state. From the state where both the button 701 and the button 702 are pressed, releasing either button while continuing to press the other button causes a transition back to the first stage state, and further, releasing both buttons returns the operation member to the initial state, which is the no-input state. Here, the buttons may be any two components of the operation unit 70 of the image capturing apparatus 200 or a combination of one component on the operation unit 70 and a button included in the lens unit 100.

Thus, in the case of combining two buttons, the recommended and not recommended combinations of functions may be changed depending on the layout of the two buttons. For example, when a two-stage operation is performed using two buttons arranged on the front side (user side) of the main body of the image capturing apparatus 200 in a state where the user is gripping the main body of the image capturing apparatus 200 while looking through the viewfinder 16, it may be difficult to press both buttons. FIG. 6C illustrates an information table 602 indicating combinations of functions to be assigned to the two buttons. Number 1 and Number 2 in FIG. 6C illustrate an example where an AF object tracking function is assigned to a first-stage function and a function using line-of-sight input is assigned to a second-stage function. The function using line-of-sight input is performed based on the premise that the user is looking through the viewfinder 16. Accordingly, it is difficult for the user to simultaneously press the two buttons when they are both located on the front side of the main body while gripping the main body of the image capturing apparatus 200. For this reason, the combination corresponding to Number 1 is “not recommended.” In contrast, when the two buttons are arranged on the front side of the main body of the image capturing apparatus 200 and on the lens side, respectively, the user can simultaneously press the two buttons while gripping the main body of the image capturing apparatus 200. For this reason, the combination corresponding to Number 2 is “recommended.”

### Other Embodiments

While the present disclosure is described in detail above based on embodiments, the present disclosure is not limited to these specific embodiments. Various embodiments that do not depart from the essence of the technical idea are also encompassed within the scope of the disclosure. Some of the embodiments described above may be combined as appropriate.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-173833, filed Oct. 2, 2024, the entirety of which is incorporated herein by reference.

What is claimed is:

1. An electronic device comprising:
a first operation unit configured to receive a first operation and a second operation subsequent to the first operation;
at least one memory storing a program; and
at least one processor that, upon execution of the stored program, is configured to function as:
an assignment unit configured to assign a function to each of the first operation and the second operation in response to a user selecting the function;
a processing unit configured to execute processing corresponding to the function assigned to the first operation in response to the first operation unit receiving the first operation and execute processing corresponding to the function assigned to the second operation in response to the first operation unit receiving the second operation; and
a control unit configured to, when the user selects the function to be assigned to one of the first operation or the second operation, perform control to notify the user of either a recommended function or a not recommended function based on the function assigned to the other of the first operation or the second operation.

2. The electronic device according to claim 1, wherein, when the user selects the function to be assigned to one of the first operation or the second operation, the control unit performs control to notify the user of the not recommended function based on the function assigned to the other of the first operation or the second operation.

3. The electronic device according to claim 1, wherein, when the user selects the function to be assigned to one of the first operation or the second operation, the control unit performs control to notify the user of the recommended function based on the function assigned to the other of the first operation or the second operation.

4. The electronic device according to claim 1,
wherein the control unit determines the recommended function and the not recommended function based on the function assigned to the other of the first operation or the second operation, and
wherein the control unit performs control to notify the user of the recommended function for the function determined to be the recommended function and notify the user of the not recommended function for the function determined to be the not recommended function.

5. The electronic device according to claim 4,
wherein the electronic device is an image capturing apparatus configured to capture an image and play back the image, and
wherein the control unit determines, in a case where the function assigned to the other of the first operation or the second operation is a function related to image playback, the function related to image playback to be the recommended function, and determines, in a case where the function assigned to the other of the first operation or the second operation is a function related to image capturing, the function related to image playback to be the not recommended function.

6. The electronic device according to claim 4, wherein the control unit determines whether the function selected by the user is the recommended function or the not recommended function based on an information table indicating preliminarily set combinations of functions.

7. The electronic device according to claim 1, wherein the not recommended function is a function unrelated to the function assigned to the other of the first operation or the second operation.

8. The electronic device according to claim 1, wherein the recommended function is a function related to the function assigned to the other of the first operation or the second operation.

9. The electronic device according to claim 1, wherein the functions assignable to each of the first operation and the second operation comprise a first-type function or a second-type function, and
wherein, when the user selects the function to be assigned to one of the first operation or the second operation, the control unit performs control to notify, in a case where the function assigned to the other of the first operation or the second operation is the first-type function, the user of the first-type function as the recommended function or the second-type function as the not recommended function, and performs control to notify, in a case where the function assigned to the other of the first operation or the second operation is the second-type function, the user of the second-type function as the recommended function or the first-type function as the not recommended function.

10. The electronic device according to claim 9,
wherein the electronic device is an image capturing apparatus configured to capture an image and play back the image, and
wherein the first-type function is one of a function related to image capturing or a function related to image playback, and the second-type function is the other of the function related to image capturing or the function related to image playback.

11. The electronic device according to claim 1,
wherein the electronic device is an image capturing apparatus configured to capture an image and play back the image, and
wherein, in a case where the function assigned to the other of the first operation or the second operation is a function related to image playback, the control unit performs control so that in response to the user selecting a function related to image capturing as the function to be assigned to one of the first operation or the second operation, a notification indicating that the selected function is the not recommended function is provided to the user, and that in response to the user selecting a function related to image playback as the function to be assigned to one of the first operation or the second operation, the notification indicating that the selected function is the not recommended function is not provided to the user.

12. The electronic device according to claim 1,
wherein the electronic device is an image capturing apparatus configured to capture an image and play back the image, and
wherein, in a case where the function assigned to the other of the first operation or the second operation is a function related to image playback, the control unit performs control so that in response to the user selecting a function related to image playback as the function to be assigned to one of the first operation or the second operation, a notification indicating that the selected function is the recommended function is provided to the user, and that in response to the user selecting a function related to image capturing as the function to be assigned to one of the first operation or the second operation, the notification indicating that the selected function is the recommended function is not provided to the user.

13. The electronic device according to claim 1, wherein the first operation is a half-press operation and the second operation is a full-press operation.

14. The electronic device according to claim 1, further comprising a second operation unit configured to receive the first operation and the second operation subsequent to the first operation, the second operation unit being different from the first operation unit,
wherein the second operation unit is a shutter button.

15. The electronic device according to claim 1, wherein the control unit performs control to notify the user that the selected function is the recommended function or the not recommended function by displaying guidance.

16. The electronic device according to claim 1,
wherein the control unit performs control to display, on a display unit, a selection screen for prompting the user to select the function to be assigned to one of the first operation or the second operation from among a plurality of functions, and
wherein the control unit performs control to notify the user of either the recommended function or the not recommended function by displaying the plurality of functions on the selection screen in such a manner that the recommended function and the not recommended function are distinguishable from each other based on the function assigned to the other of the first operation or the second operation.

17. The electronic device according to claim 16, wherein the control unit performs control to display the plurality of functions on the selection screen such that the recommended function and the not recommended function are displayed in different display forms.

18. The electronic device according to claim 16, wherein the control unit performs control to display the plurality of functions on the selection screen with the recommended function and the not recommended function being grouped separately.

19. A method for controlling an electronic device, the method comprising:
assigning a function, in response to a user selecting the function, to each of a first operation and a second operation of a first operation unit configured to receive the first operation and the second operation subsequent to the first operation;
executing processing corresponding to the function assigned to the first operation in response to the first operation unit receiving the first operation and executing processing corresponding to the function assigned to the second operation in response to the first operation unit receiving the second operation; and
when the user selects the function to be assigned to one of the first operation or the second operation, performing control to notify the user of either a recommended function or a not recommended function based on the function assigned to the other of the first operation or the second operation.

20. A non-transitory computer-readable recording medium recording a program for causing a computer to execute the method for controlling the electronic device according to claim 19.
